(19) United States
(12) Patent Application Publication
(10) Pub. No.: US 2011/0140845 A1
(43) Pub. Date: Jun. 16, 2011

(54) PERSONAL SAFETY DEVICE

(76) Inventor: Brent Sanders, Clovelly (AU)

(21) Appl. No.: 13/002,146

(22) PCT Filed: Jul. 17, 2009
(86) PCT No.: PCT/AU2009/000913

§ 371 Date: Mar. 3, 2011

(30) Foreign Application Priority Data
Jul. 18, 2008 (AU) 2008903682

(51) Int. Cl. G08B 5/00; B05B 9/04

(52) U.S. Cl. 340/6.1; 239/337

(57) ABSTRACT

There is disclosed a personal safety device having one or more lamps and lamp lenses located at the end of a body, and wherein pressure applied at least one lens causes a control circuit to initiate a mode of operation of the device.

### FIELD OF THE INVENTION

The field of the invention relates generally to personal safety and more particularly to a personal safety device.

### BACKGROUND

Today, many innocent people find themselves victims of crime. The nature of the crime varies from minor misdemeanors, such as theft, to violent assault, such as rape or murder. Typically, the victim of a crime is physically unable to prevent or deter an attack.

The need therefore exists for a personal safety device to enable a victim to prevent, deter or defeat an attack. As such, many people have resorted to carrying lethal weapons, such as hand guns. However, in certain jurisdictions, a person is forbidden by law to possess or use a lethal weapon.

The need therefore exists for a non-lethal personal safety device to enable a person to prevent, deter or defeat an attack.

A further need exists for a personal safe device that allows a person to signal for help in the event of an attack.

### SUMMARY

There is disclosed a personal safety device comprising: a graspable body; a control circuit located within said body; one or more lamps located at a respective end of said body; and one or more lamp lenses covering a respective said lamp; and wherein pressure applied to at least one said lenses causes said control circuit to initiate a mode of operation of said device.

Preferably, the device further comprises an alarm device operable by the control circuit in an alarm mode of operation. Further, the mode of operation can be initiated by at least one of: illuminating at least one the lamp, and emitting an audible alarm from said alarm device. The mode of operation can be deactivated by the control circuit by at least one of: depressing one of said lenses for longer than a first predetermined amount of time, and waiting for a second predetermined amount of time to elapse. The lamps can comprise one or more LEDs. Further, the device can comprise means to deliver a chemical spray, wherein the emission of the chemical spray is initiated by the control circuit in response to at least one of: squeezing the body of the device, twisting the body of the device, shaking the body of the device, and applying pressure to at least one of the lenses. A locking means can be coupled to the control circuit to prevent the initiation of said mode of operation. A rechargeable battery can be located within the body. An indicator can indicate the charge status of the battery pack. A power button can be coupled to the control circuit for initiation of at least one mode of operation of the device. The body is shaped to allow for a one-handed grip. A lanyard or a hand strap can be connected to the body.

### DRAWINGS

One or more embodiments of the present invention will now be described with reference to the drawings, in which:

FIG. 1 shows a perspective view of the personal safety device;

FIG. 2 shows the top, side and bottom view of the personal safety device;

FIG. 3 is an exploded view showing the components of the personal safety device;

FIG. 4 shows the schematic of the front PCB of the personal safety device;

FIG. 5 shows the schematic of the rear PCB of the personal safety device;

FIG. 6 shows the method of transitioning between four typical modes of operation of the personal safety device when the power button is depressed;

FIG. 7 shows the method of transitioning between the various alarm modes of the personal safety device; and

FIG. 8 shows the modes of operation of the charge indicator according to the charge status of the battery pack of the personal safety device.

### DETAILED DESCRIPTION

### Construction

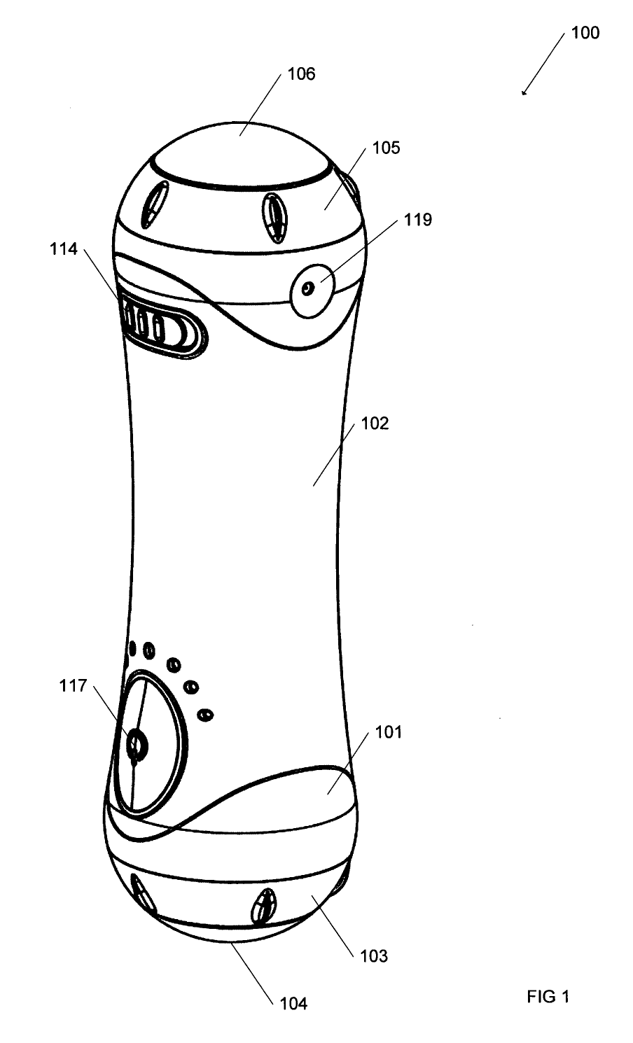

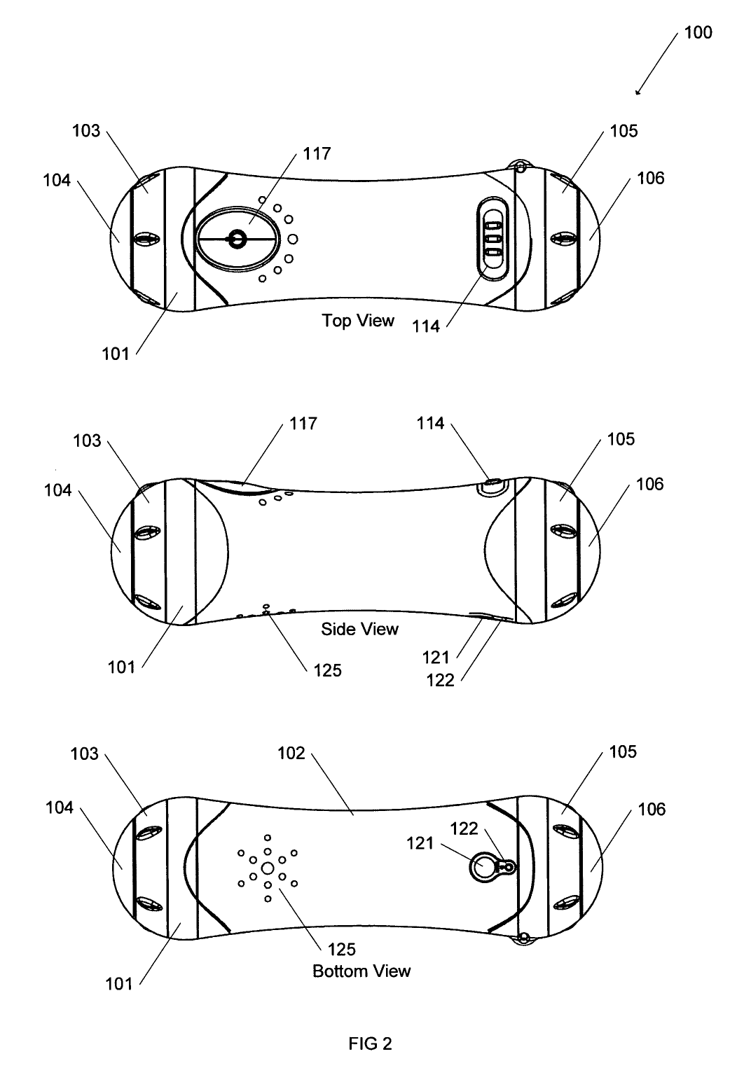

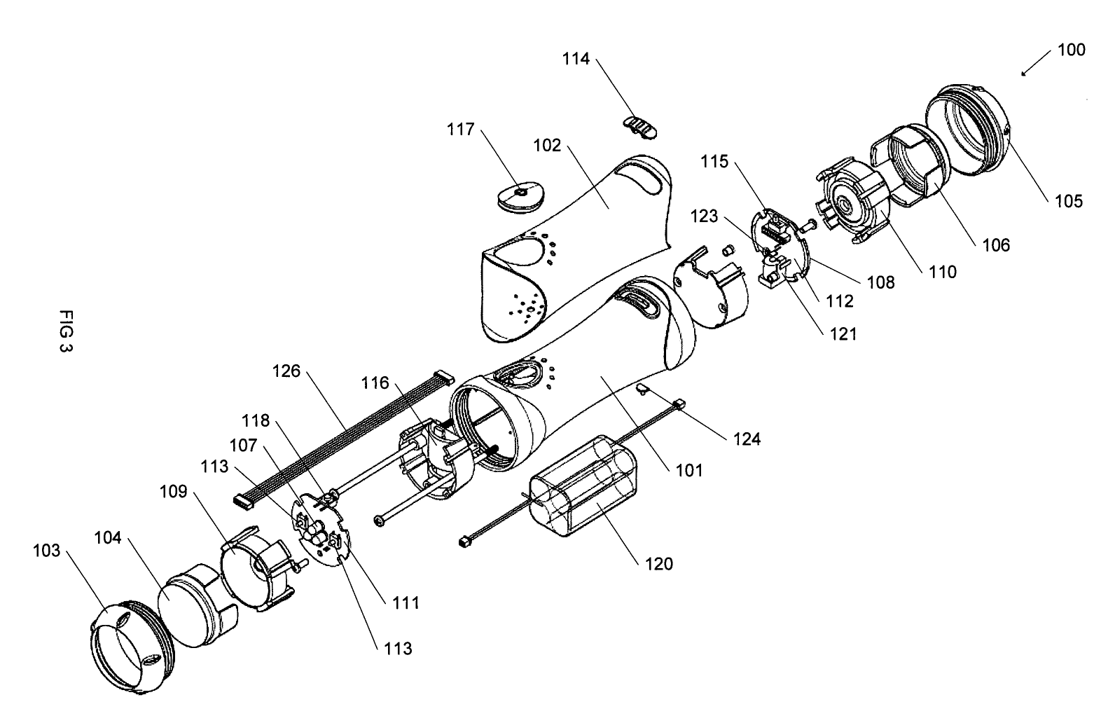

FIG. 1 shows a perspective view of a personal safety device 100. FIG. 2 shows the top, side and bottom view of the personal safety device 100. FIG. 3 is an exploded view showing the components of the personal safety device 100.

The body 101 of the personal safety device 100 is ergonomically designed so as to allow a user to grip it easily in one hand. The body 101 is designed to allow the user to strike an attacker and is therefore formed of high strength plastics or metal. The body 101 is sheathed in a rubber material (or equivalent) 102 to provide a non-slip grip for the user.

The body 101 further consists of a front cap 103 for housing a front lens 104 and a rear cap 105 for housing a rear lens 106. The front lens 104 and rear lens 106 are made of high strength transparent plastics or glass. The front lens 104 and rear lens 106 may also be coloured and opaque.

The front lens 104 covers a front lamp 107. In a preferred embodiment, the front lamp 107 may consist of one or more high brightness white LEDs. Similarly, the rear lens 106 covers a rear lamp 108. In a preferred embodiment, the rear lamp 108 may consist of one or more high brightness red LEDs. However, other light emitting lamps may be used, such an incandescent, florescent, HID (High Intensity Discharge) or halogen types.

The light emitted by lamps 107 and 108 is focused by means of a front reflector 109 and rear reflector 110 respectively. Lamp 107 is mounted on a front PCB 111 and lamp 108 is mounted on a rear PCB 112.

The front PCB 111 and the rear PCB 112 contain a plurality of push button type alarm switches 113. The front lens 104 and rear lens 106 are mounted such that externally applied pressure will cause the front lens 104 or rear lens 106 to recess into the body 101 and activate one or more alarm switches 113. In this manner, a user of the personal safety device 100 is able to activate an alarm mode of the personal safety device 100 by striking either the rear lens 106 or the front lens 104.

In order to prevent the accidental triggering of an alarm, the personal safety device 100 is provided with an alarm lock slider 114 that actuates an 115 on the rear PCB 112. In this manner, when the alarm lock slider 114 is in the alarm lock position, striking the front lens 104 or rear lens 106 of the device will not activate the alarm. Should the user of the personal safety device 100 wish to activate the alarm, they should first position the alarm lock slider 114 in the unlocked position and then strike either the front lens 104 or the rear lens 106. Typically, once the alarm has been activated, placing the alarm lock slider 114 in the locked position will not deactivate the alarm. To deactivate the alarm once it has been triggered, the front lens 104 or the rear lens 106 must be depressed for a certain amount of time, such three seconds. Alternatively, the alarm will automatically deactivate after a certain interval, such as thirty seconds.

The body 101 contains an alarm device 116 that is positioned next to an alarm aperture 125 to emit a high intensity audible alarm. In this manner, once the personal safety device 100 alarm mode has been activated, lamps 107 and 108 flash and the alarm device 116 emits an audible alarm.

The body 101 is provided with a power button 117 that controls the modes of operation of the personal safety device 100. The front PCB 111 contains a push button type power switch 118. Depressing the power button 117 will actuate the power switch 118. The power button 117 may cause the personal safety device to iterate through several modes of operation. For instance, a first mode of operation may cause lamps 107 and 108 to be constantly illuminated. A second mode may cause the front lamp 107 to be constantly illuminated and the rear lamp 108 to flash. The third mode may cause both the front lamp 107 and the rear lamp 108 to flash. The fourth mode may cause the lamps 107, 108 not to be illuminated.

In a particular embodiment, the body 101 is provided with a spray nozzle 119 for ejecting a defense chemical contained within a canister contained within the body 101. The chemical used may be of the deterrent type, such as capsicum spray or tear gas, or it may be a dye used for identification of the attacker. The dye may be visible stain. The dye may also be invisible except under ultraviolet light. The spray may be activated by squeezing the body 101 of the personal safety device, twisting an end cap 105, 103 of the device or other similar action.

The body 101 contains a battery pack 120 to provide power to the electronics of the personal safety device 100. The battery pack 120 may be rechargeable. The battery pack 120 may be charged via the charge port 121. The battery pack may typically provide 12V DC.

The body 101 contains a charge indicator 122 that indicates the charging status of the personal safety device 100. The charge indicator 122 consists of a charge indicator LED 123 mounted on the rear PCB 112 and the charge LED light pipe 124 to direct the light from the charge indicator LED 123. The charge indicator 122 indicates the charge status of the battery pack 120. For example, in a first mode, where the voltage of the battery pack 120 is sufficient to power the componentry of the personal safety device 100, the charge indicator LED 123 will remain not illuminated. In a second mode where the voltage of the battery pack 120 is insufficient to adequately power the componentry of the personal safety device 100, the charge indicator LED 123 may flash. In a third mode, when the battery pack 120 is being charged by the charge port 121 the charge indicator LED 123 may be constantly illuminated.

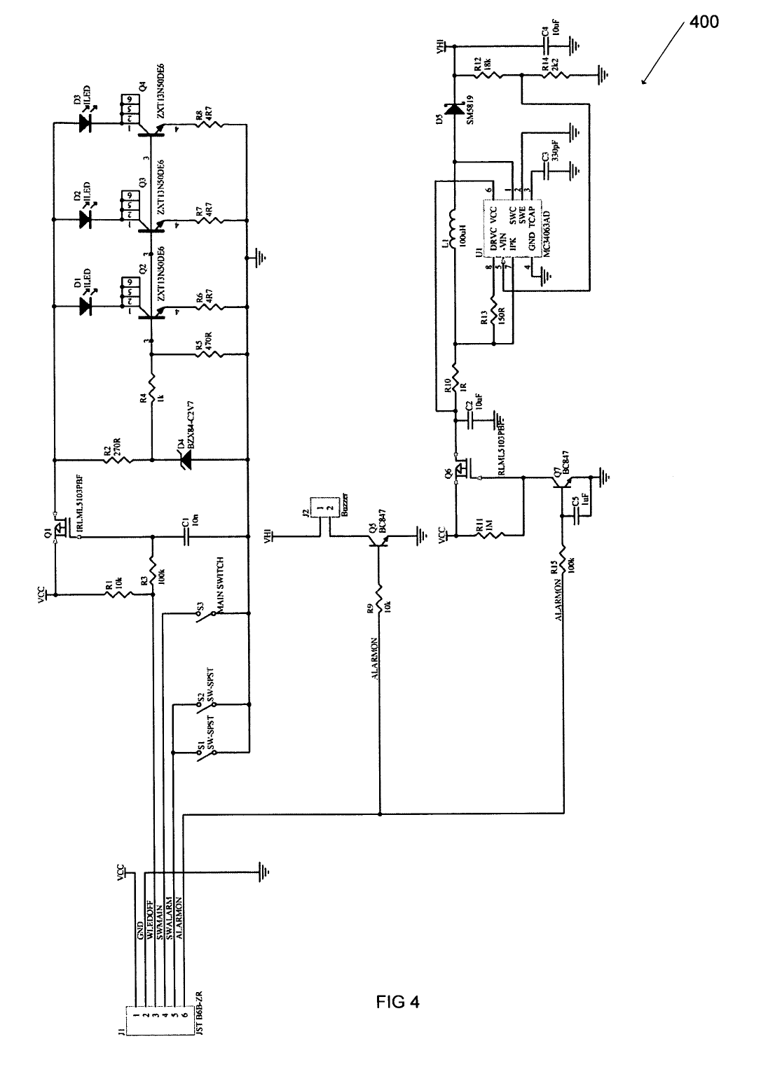

FIG. 4 shows a schematic circuit diagram 400 of the front PCB 111. The components of PCB 111 correspond to the items of the personal safety device 100 as shown in Table 1.

TABLE 1
Components of PCB 111 correspond to the items of
personal safety device 100

| Description | PCB 111 | Safety device 100 |
|---|---|---|
| Front lamp | D1, D2, D3 | 107 |
| Power switch | S3 | 118 |
| Alarm switches | S1, S2 | 113 |
| Alarm device | J2 (connectors for) | 116 |

PCB 111 comprises DC to DC converter U1 to convert the voltage supply VCC to voltage supply VH1 suitable for the alarm device 116. The DC to DC converter U1 may be the Fairchild MC 34063AD SMPS controller. The DC to DC converter U1 may be provided with additional components typically as specified by the manufacturer datasheet according to the desired operational requirements. Modifications of the additional components are within the scope of a person skilled in the art.

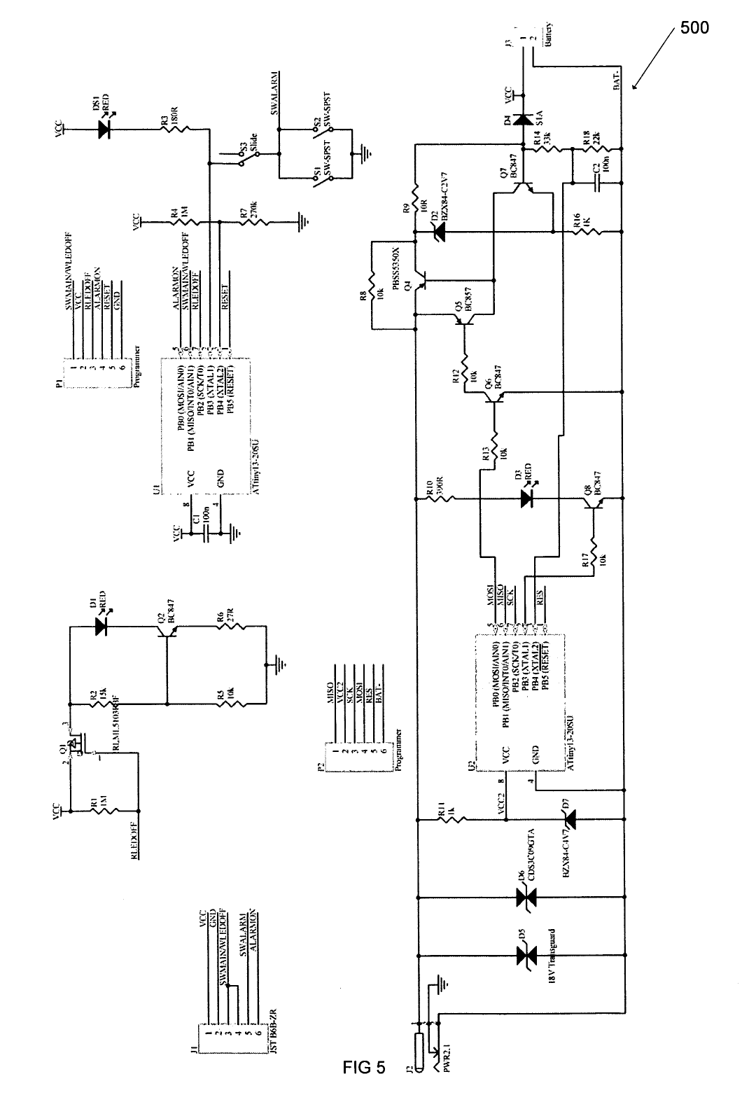

The front PCB 111 is connected to rear PCB 112 (shown in FIG. 5) via the PCB link cable 126. PCB 111 comprises connector J1 for connection of the PCB link cable 126.

FIG. 5 shows a schematic circuit diagram 500 of the rear PCB 112. The components of PCB 112 correspond to the items of personal safety device 100 as shown in Table 2.

TABLE 2
Components of PCB 112 correspond to the items of
personal safety device 100

| Description | PCB 111 | Safety device 100 |
|---|---|---|
| Rear lamp | D1 | 108 |
| Charge | D3 | 123 |
| indicator LED | | |
| Alarm switches | S1, S2 | 113 |
| Alarm lock | S3 | 115 |
| switch | | |
| Battery pack | J3 (connector for) | 120 |

The rear PCB 112 comprises microcontroller programmable flash devices U1 and U2 to control the operation of personal safety device 100. The programmable flash devices may be the 8-bit AVR® microcontroller with 1K bytes of system programmable flash.

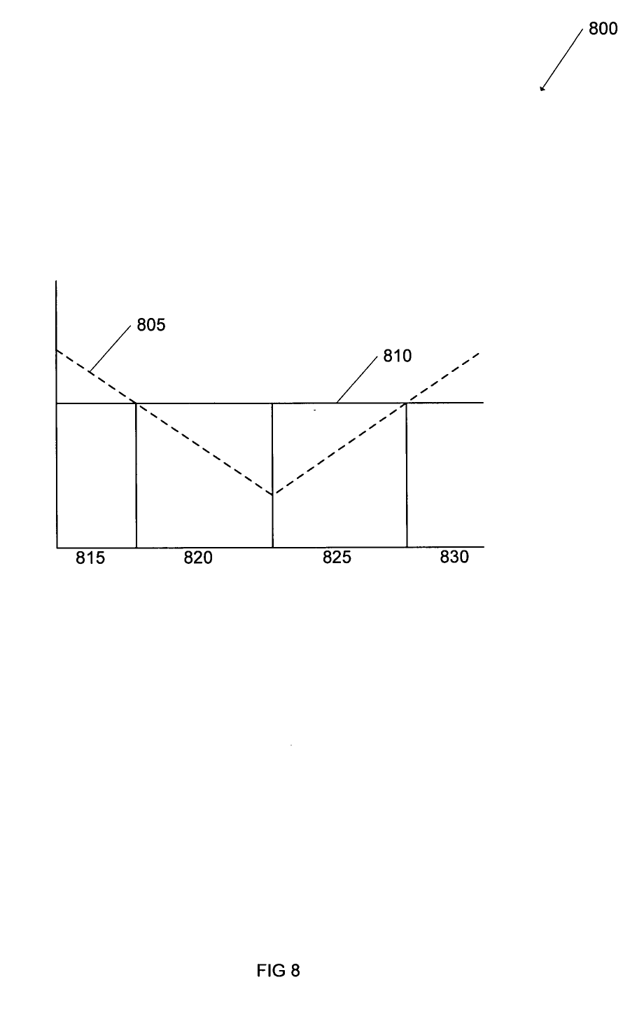

Device U2 controls the charge and discharge of the battery pack 120 as is readily apparent to a person skilled in the art. Connector J2 is positioned in charge port 121. U2 controls the illumination of LED D3 as shown in FIG. 8. Device U2 is provided with additional reverse polarity and transient overvoltage protection circuitry as show in FIG. 5. The additional circuitry may be modified by a person skilled in the art.

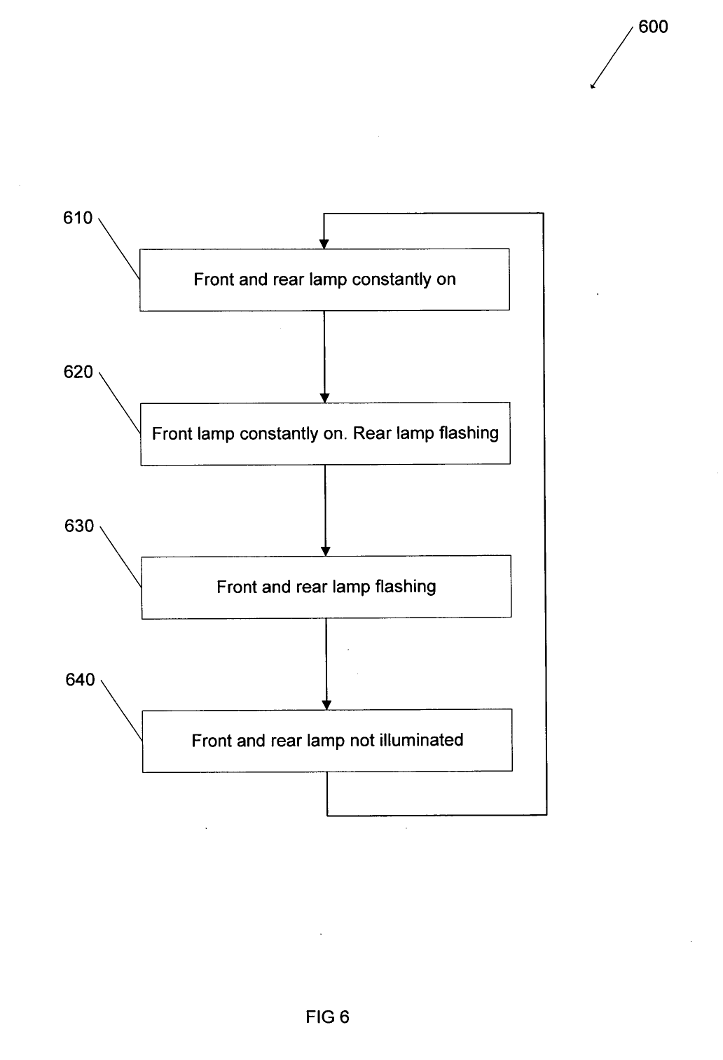

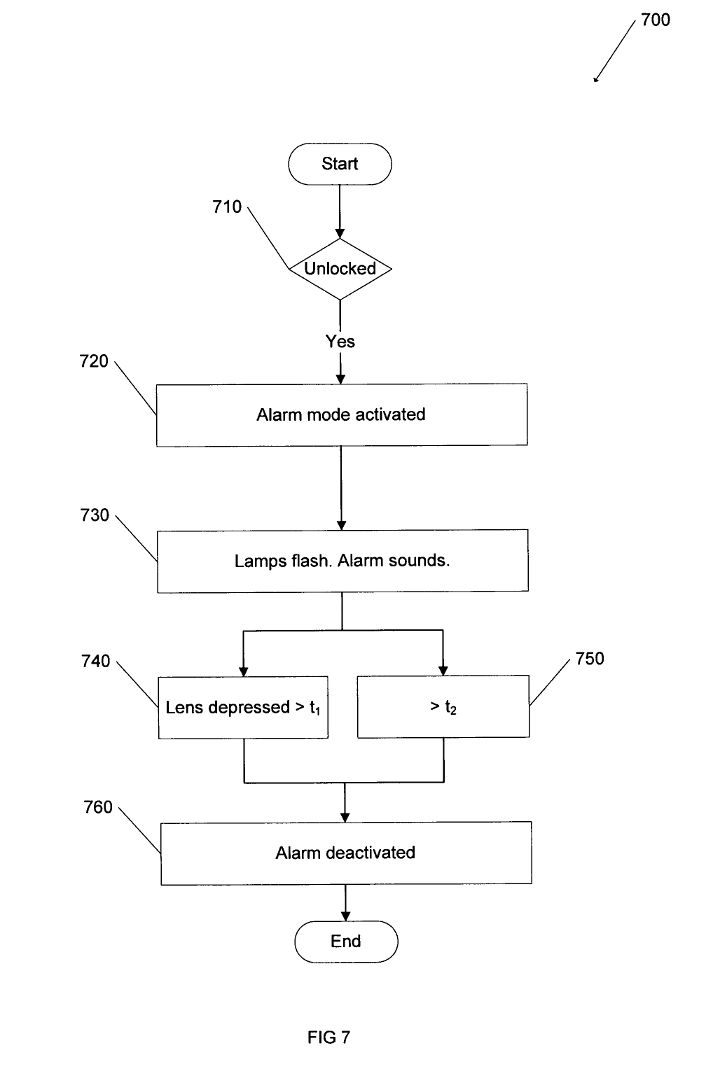

Device U1 is programmed to operate the safety device 100 in the manner shown in the methods of FIGS. 6 and 7. Specifically, U1 is programmed to operate the personal safety device 100 is as follows: The contact of S1 or S2 of FIG. 4 or S1 or S2 of FIG. 5 will ground net SWALARM. If S3 of FIG. 5 is in the alarm position as shown, pin PB3 of U1 will be grounded and alarm LED DS1 will illuminate. U2 is programmed to signal net ALARMON to activate the alarm device in the manner shown in FIG. 7. U2 will ground net ALARMON after period t₂, or after the contact of S1 or S2 of FIG. 4 or S1 or S2 of FIG. 5 for a period greater than t₁, deactivating the alarm device 116. Similarly U1 will signal net WLEDOFF to flash lamps 107 and 108. Furthermore, activation of switch S3 of PCB 111 will cause net SWMAIN to be grounded causing U1 to signal nets WLEDOFF and RLEDOFF in the manner shown in FIG. 6.

PCB 112 comprises connector J1 for connection of the PCB link cable 126.

The operation of PCB 111 and PCB 112 is readily apparent to a person skilled in the art and modifications within the scope of the operation of the safety device 100 as described are possible.

### Function

FIG. 6 shows the method of transitioning between four typical modes of operation of the personal safety device 100 when the power button 117 is depressed. The method 600 begins at a first mode of operation at step 610. In this mode, lamps 107 and 108 are constantly illuminated. Step 620 is a second mode of operation that is activated by pressing the power button 117 when the personal safety device is in the first mode of operation. In mode 620 the front lamp 107 is constantly illuminated while the rear lamp 108 is flashing. Similarly, step 630 is the third mode of operation in which the front lamp 107 and the rear lamp 108 flash. Step 640 is the fourth mode of operation in which lamps 107 and 108 are not illuminated.

FIG. 7 shows the method of transitioning between the various alarm modes of the personal safety device 100. The method 700 beings at step 710 when the alarm lock slider 114 is positioned in the unlocked position. If the alarm lock slider 114 is positioned in the locked position, the alarm mode of the personal safety device 100 cannot be activated. At step 720 the alarm mode of the personal safety device 100 is activated. The alarm mode of the personal safety device 100 is activated by depressing either the front lens 107 or the rear lens 106 of the personal safety device 100 momentarily. Step 730 is the alarm mode of the personal safety device 100. In this mode, lamps 107 and 108 flash and the alarm device 116 emits an audible alarm. In order to deactivate the alarm mode of the personal safety device 100 either step 740 or 750 should be performed. In step 740 the alarm mode of the personal safety device 100 is deactivated by depressing the front lens 104 or the rear lens 106 for a predetermined amount of time. The predetermined amount of time should typically not be very long and is typically about three seconds. In step 750 the alarm mode of the personal safety device is deactivated automatically after a predetermined amount of time. The predetermined amount of time for step 750 should be longer than the predetermined amount of time of step 740 and is typically about 30 seconds. At step 760 the alarm mode of the personal safety device 100 is deactivated. In this mode, lamps 107 and 108 cease to be illuminated and the alarm device 116 is deactivated.

FIG. 8 shows the modes of operation of the charge indicator 112 according to the charge status of the battery pack 120. Typically, the voltage of the battery pack 805 is compared to a predetermined threshold voltage 810 and the charging port 121 is monitored to determine the charge status of the battery pack 120. In this manner, in a first mode of operation 815 the voltage of the battery pack 805 is above a predetermined voltage threshold 810 indicating the voltage of the battery pack 805 is sufficient to power the componentry of the personal safety device 100. In a second mode of operation the voltage of the battery pack 805 is below the predetermined voltage threshold 810 indicating that the voltage of the battery pack 805 is insufficient to power the componentry of the personal safety device 100. In this mode the charge indicator LED 123 flashes. In a third mode of operation the battery pack 120 is being recharged via the charging port 121 and the voltage of the battery pack 805 is below the predetermined voltage threshold 810. In this mode of operation the charge indicator LED 123 is constantly illuminated. In a fourth mode of operation the voltage of the battery pack 805 while being recharged via the charging port 121 exceeds the predetermined voltage threshold 810 indicating that the voltage of the battery pack 805 is sufficient to power the components of the personal safety device 100. In this mode of operation the charge indicator LED is not illuminated.

1. A personal safety device comprising:
a graspable body;
a control circuit located within said body;
one or more lamps located at a respective end of said body; and
one or more lamp lenses covering a respective said lamp; and
wherein pressure applied to at least one said lenses causes said control circuit to initiate a mode of operation of said device.

2. The device of claim 1, further comprising an alarm device operable by said control circuit in an alarm mode of operation.

3. The device of claim 2, wherein said mode of operation initiates at least one of: illuminating at least one said lamp, and emitting an audible alarm from said alarm device.

4. The device of claim 3, wherein said mode of operation is deactivated by said control circuit by at least one of: depressing one of said lenses for longer than a first predetermined amount of time, and waiting for a second predetermined amount of time to elapse.

5. The device of claim 1, wherein said lamps comprise one or more LEDs.

6. The device of claim 1, further comprising: means to deliver a chemical spray, and wherein the emission of the chemical spray is initiated by said control circuit in response to at least one of:
squeezing the body of said device;
twisting the body of said device;
shaking the body of said device; and
applying pressure to at least one of said lenses.

7. The device of claim 1, further comprising locking means coupled to said control circuit to prevent the initiation of said mode of operation.

8. The device of claim 1, further comprising a rechargeable battery located within said body.

9. The device of claim 8, further comprising an indicator to indicate the charge status of the battery pack.

10. The device of claim 1, further comprising a power button coupled to said control circuit for initiation of at least one mode of operation of said device.

11. The device of claim 1, wherein said body is shaped to allow for a one-handed grip.

12. The device of claim 1, further comprising a lanyard or a hand strap connected to said body.

13. A personal safety device being substantially as hereinbefore described with reference to any one of the embodiments as that embodiment is shown in the accompanying drawings.
